(19) United States
(12) Patent Application Publication
(10) Pub. No.: US 2005/0163956 A1
(43) Pub. Date: Jul. 28, 2005

(54) Resin hose with resin reinforcing wire rod

(75) Inventors: Masatoshi Takashima, Osaka (JP); Tomohide Horii, Osaka (JP); Keiji Nakamata, Osaka (JP)

Correspondence Address: MCGINN & GIBB, PLLC, 8321 OLD COURTHOUSE ROAD, SUITE 200, VIENNA, VA, 22182-3817, US

(73) Assignee: Totaku Industries, Inc., Osaka (JP)

(21) Appl. No.: 11/025,596

(22) Filed: Dec. 30, 2004

(30) Foreign Application Priority Data
Jan. 9, 2004 (JP) P2004-003724

(51) Int. Cl. B32B 1/08

(52) U.S. Cl. 428/36.91

(57) ABSTRACT

In a resin tube that comprises a cylindrical tube wall made of synthetic resin material, and a resin reinforcing wire rod that is wound helically on an outer peripheral surface of the tube wall and coupled integrally, the reinforcing wire rod is formed of a transparent or semitransparent member made of rigid synthetic resin and has a recess that is formed on a part of the outer peripheral surface in the longitudinal direction.

This application claims foreign priority based on Japanese patent application JP 2004-003724, filed on Jan. 9, 2004, the contents of which is incorporated herein by reference in its entirety.

### BACKGROUND OF THE INVENTION

1. Field of the Invention

The present invention relates to a synthetic resin tube on which a reinforcing wire rod made of rigid synthetic resin is helically wound to maintain a tubular shape and reinforce the tube. More particularly, the present invention relates to a synthetic resin tube with a reinforcing wire rod, which employs a transparent wire rod as the reinforcing wire rod made of the rigid synthetic resin.

2. Description of the Related Art

In the related art, as the synthetic resin tubes having the reinforcing wire rod made of the rigid synthetic resin of this type, the synthetic resin tubes having various shapes have already been manufactured and well known commonly. However, most of these reinforcing wire rods made of the rigid synthetic resin are rendered opaque by mixing a coloring agent into the resin material.

In the related art, a reason why the reinforcing wire rod of the synthetic resin tube of this type is manufactured as the opaque one is due to that the technological means for preventing generation of air bubbles in an inside of the resin reinforcing wire rod upon manufacturing has not been found out yet. In the related art, by manufacturing the reinforcing wire rod as opaque one, even though the air bubbles are generated in the inside, it is hard to check easily and visually whether or not the wire rod contains the air bubbles from an exterior view of the wire rod.

In the case where the resin reinforcing wire rod contains the air bubbles, deterioration in a predetermined pressure flat strength is brought about, particularly the strength of the air bubble containing portions is deteriorated, and also such air bubbles act as the cause or the distant cause of generation of the crack. Thus, the generation of the air bubbles in the molding step must be eliminated completely. At the same time, there a necessity for making it possible to check easily from the outside whether or not the air bubbles are present in the wire rod.

It was found that the air bubble generating mechanism is considered as follows. That is, as shown in FIG. 6, first the outer surface is solidified by the rapid cooling of the wire rod, this solidification works as if it is a pressure tank. Then a pressure in the interior of the wire rod is lowered since the outer peripheral shell is not shrunken regardless of the shrinkage of the internal volume due to the crystallization of the material caused by the gradual cooling that proceeds gradually inwardly, etc., and then either the volatile component contained the material is vaporized or the gas contained in the ultra fine state is expanded.

However, it is the existing state of the resin reinforcing wire rod in resin tube materials of this type that particular attention, studies and concernment to satisfy the above necessities are not taken into account at all. See Japanese patent Application No. 2001-317672 and M. Horino: “Introduction to Material Mechanics”, issued by Rikogakusha Publishing Co. Ltd., pp. 124-127, 1993.

### SUMMARY OF THE INVENTION

Therefore, in order to overcome such subject involved in a resin reinforcing wire rod in the related-art resin tube, it is an object of the present invention to obtain a resin tube with a resin reinforcing wire rod, capable of reducing generation of air bubbles by devising a shape of the wire rod and also capable of checking easily the presence or absence of the air bubbles from the outside with the eye.

For an explanation of a structure of a resin tube with resin reinforcing wire rod applied in the present invention to attain the above object, such a structure is employed that a resin tube that comprises a cylindrical tube wall 1 made of synthetic resin material, and a resin reinforcing wire rod 2 that is wound helically on an outer peripheral surface of the tube wall 1 and coupled integrally, wherein the reinforcing wire rod 2 is formed of a transparent or semitransparent member made of rigid synthetic resin and has a recess 3 that is formed on a part of an outer peripheral surface in a longitudinal direction.

The resin tube with the resin reinforcing wire rod of the present invention is constructed to have such a structure that the reinforcing wire rod 2 is formed of the transparent or semitransparent member made of the rigid synthetic resin and also the sectional shape of the reinforcing wire rod 2 has the recess 3 in the cross section. Thus, the outer peripheral shell formed when the surface of the wire rod is cooled and solidified does not become the complete one, and thus is shaped into the sectional shape a part of which is lost. Therefore, the outer peripheral shell is shrunken subsequently to the shrinkage of the internal volume due to the crystallization of the material caused by the gradual cooling that proceeds gradually inwardly, etc., and thus the pressure in the inner side is never lowered. As a result, neither the volatile component contained the material is vaporized nor the gas at the ultra fine state is expanded, so that the wire rod containing no air bubble and having a clear external appearance can be obtained.

The resin reinforcing wire rod obtained in this manner to contain no air bubble has a desired strength uniformly in the overall wire rod. Therefore, the wire rod of uniform quality, in which neither the strength is lowered partially or locally owing to the presence of the contained air bubbles nor the weak portions acting to cause the generation of cracks are generated, can be manufactured. As a result, the tube member reinforced by such wire rod is excellent in the pressure flat strength, and thus such tube member can be used safely for a long term as the tube that has the less time-dependent degradation.

In addition, the wire rod itself is formed as the transparent member or the semitransparent member into which the coloring agent is added. Therefore, the presence or absence of the air bubbles can be checked easily from the outside and also the machine can be immediately repaired/adjusted when the air bubbles are generated in the wire rod at the time of production. As a result, there can be achieved such an advantage that the excellent wire rod that contains no air bubble therein can be always produced.

### BRIEF DESCRIPTION OF THE DRAWINGS

FIG. 1 is a partial sectional view showing a tube member in a main embodiment of the present invention.

FIG. 2 is a front view showing the tube member from which the tube wall in FIG. 1 is partially cut away.

FIG. 3 is a perspective view of a wire rod.

FIG. 4 is a sectional view of the same wire rod.

FIG. 5 is an end view showing another shape of the wire rod.

FIG. 6 is an explanatory view explaining cured states of the wire rod.

### DETAILED DESCRIPTION OF THE INVENTION

In order to obtain the reinforcing wire rod of the resin tube with resin reinforcing wire rod constructed as above in the present invention, it is preferable from the viewpoint of making the depositing position to the tube wall 1 hold easily constant that a schematic shape of a cross section should be embodied like a semicylindrical shape or a tunnel shape having a flat bottom surface. Also, it is preferable that non-vinyl chloride based crystalline resin material such as polypropylene (PP), polyethylene (PE), polyethylene terephthalate (PET), polytetrafluoroethylene (PTFE), polyacetal (POM), polyamide (PA), or the like, for example, should be employed as the forming material of the wire rod. Also, these materials are preferable from the viewpoint of not emitting the harmful substance upon processing the waste lumber after the disposal process.

Similarly, it is preferable for the same reason that non-vinyl chloride based resin material such as olefin elastomer, ethylene-vinyl acetate copolymer (EVA), styrene elastomer (e.g., styrene-butadiene-styrene block copolymer (SBS), styrene-butadiene-styrene hydrogenated block copolymer (SEBS), styrene-isoprene-styrene block copolymer (SIS), styrene-isoprene-styrene hydrogenated block copolymer (SEPS), styrene-isoprene hydrogenated block copolymer (SEP), etc.), polyurethane elastomer, polyester elastomer, or the like, for example, should be employed as the forming material of the tube wall 1.

### EXAMPLES

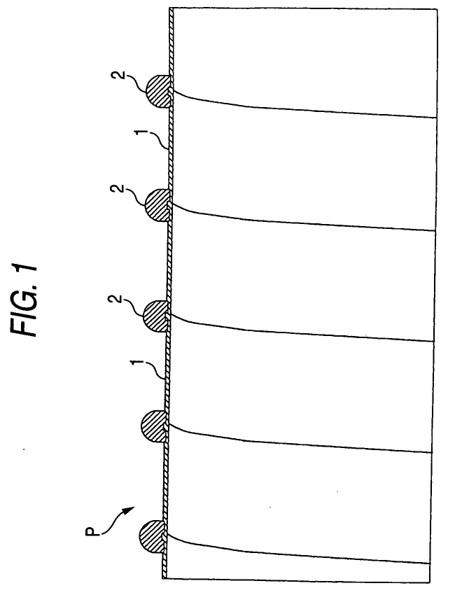

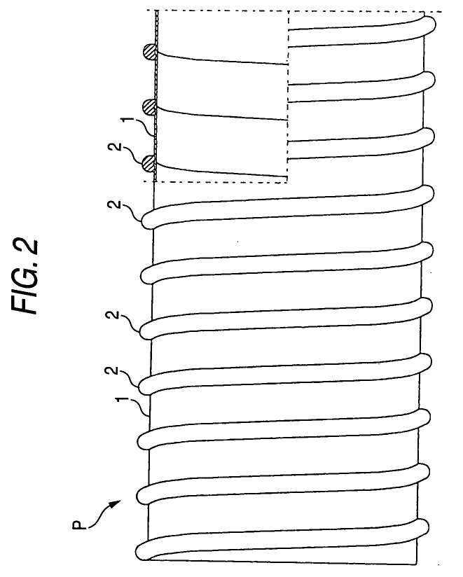

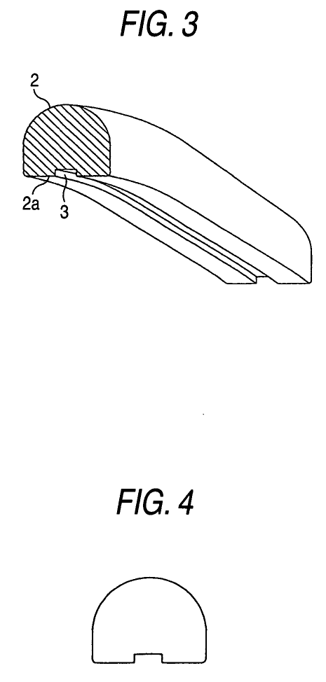

Examples of the present invention will be explained with reference to the drawings hereinafter. In Figures, FIG. 1 to FIG. 4 are views showing main embodiments of the present invention. More specifically, FIG. 1 is a partial sectional view of a tube member showing a relationship between a tube wall and a wire rod, FIG. 2 is a front view of the tube member from which the tube wall is partially cut away, FIG. 3 is a perspective appearance view showing a shape of the wire rod, and FIG. 4 is a sectional view of the same wire rod.

A tube member P shown in FIG. 1 and FIG. 2 is constructed such that a tube wall 1 is formed cylindrically by winding helically a strip material in such a way that its side edge portion is overlapped partially with each other and is fused mutually, while extruding the material from a resin extruder (not shown). The strip material is made of olefin elastomer and has a sectional shape formed in a lateral straight line.

Then, a wire rod 2 formed of a white transparent rigid polyethylene resin is extruded from a resin extruder (not shown) onto an outer peripheral surface of the cylindrical tube wall 1 constructed as the above in such a manner that the wire rod 2 is wound helically to be overlapped with the fused portion of the strip material of the tube wall 1, and thus the bottom surface 2a is fused onto the tube wall 1. As shown in FIG. 3 and FIG. 4 in an enlarged fashion, this wire rod 2 has a schematic sectional shape that is shaped into an almost semicircular shape or a dome shape a bottom surface 2a of which is made flat and a top portion of which is projected like a mound. Also, a recess 3 is formed in this wire rod by making a hollow in a middle portion upwardly in the longitudinal direction.

The wire rods having the tube member P with the tube structure shown in the embodiment, which are concluded as optimal ones, were obtained experimentally every outer diameter φ of the tube wall 1, and are given in Table 1 as a list. Where A is a height of the wire rod, B is a lateral width, C is a depth of the recess 3 (notch height) D is an occupying rate to a height of the wire rod, E is a lateral width of the recess 3 (notch width), and F is an occupying rate to a lateral width of the wire rod.

TABLE 1

| | Size | | | | | |
|---|---|---|---|---|---|---|
| | A | B | C | | E | |
| | Rigid | Rigid | Notch | | Notch | |
| | height | width | height | D | width | F |
| | (mm) | (mm) | (mm) | % | (mm) | % |
| φ 32 | 2.5 | 3.1 | 0.21 | 8.40 | 0.57 | 18.39 |
| φ 38 | 3.0 | 3.6 | 0.26 | 8.67 | 0.46 | 12.78 |
| φ 50 | 3.3 | 4.3 | 0.28 | 8.48 | 0.71 | 16.51 |
| φ 65 | 4.0 | 4.7 | 0.45 | 11.25 | 0.85 | 18.09 |
| φ 75 | 4.0 | 4.0 | 0.61 | 15.25 | 0.85 | 21.25 |
| φ 90 | 4.2 | 4.8 | 0.65 | 15.48 | 0.92 | 19.17 |
| φ 100 | 4.2 | 4.8 | 0.69 | 16.43 | 1.13 | 23.54 |
| φ 125 | 5.7 | 6.7 | 0.71 | 12.46 | 1.34 | 20.00 |
| φ 150 | 5.0 | 5.9 | 0.74 | 14.80 | 2.25 | 38.14 |
| φ 200 | 5.0 | 5.7 | 0.59 | 11.80 | 1.90 | 33.33 |

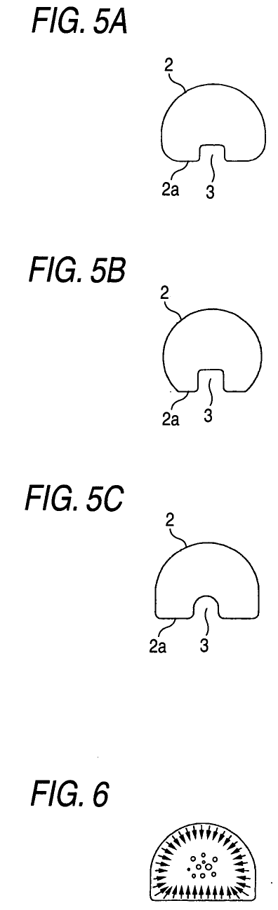

Subsequently, typical examples of another shape of the wire rod of the embodiment are shown in FIG. 5. In the present invention, the wire rod 2 is signified to have the flat bottom surface 2a in the above embodiment. In a wire rod shown in A of FIG. 5, both outer end portions of the bottom surface 2a are formed like a large circular arc. In a wire rod shown in B of FIG. 5, the whole portion is formed like an almost circular arc. Also, for example, an almost square shape upper left and right corner portions of which are formed like a circular arc may be embodied. Similarly, an almost trapezoidal shape upper left and right corner portions and lower left and right corner portions of which are formed like a circular arc, and the like may be embodied. Further, the oblong shape is shown as the shape of the recess 3 in the embodiment, but appropriate shapes may be embodied. For example, as shown in C of FIG. 5, an almost inverted U-shape inner corner portions of which are formed like a circular arc, and the like may be embodied. The shape having a large overall height is preferable from the viewpoint of the shape-holding ability of the tube, while the wide shape having the flat bottom surface is preferable from the viewpoint of the positional stability of the core material in producing the tube. Therefore, various appropriate shapes may be embodied with regard to these viewpoints.

With the above, explanation of the typical embodiments of the present invention is made, but the present invention is not always limited only to the structures shown in these embodiments. The present invention may be varied and modified appropriately within a scope to satisfy the constituent requirements, attain the object, and achieve the advantages of the present invention.

The rigid synthetic resin pressure helical tube of the present invention is excellent in a pressure deforming performance, is light in weight, and is provided at a low cost to the market. Therefore, such rigid synthetic resin tube is not limited to the particular fields such as the duct pipe, and the like, and can be utilized in the broad industrial fields.

1. A resin tube comprising:
a cylindrical tube wall made of synthetic resin material; and
a resin reinforcing wire rod that is wound helically on an outer peripheral surface of the tube wall and coupled integrally, the reinforcing wire rod being formed of a transparent or semitransparent member made of rigid synthetic resin and having a recess that is formed on a part of an outer peripheral surface in a longitudinal direction.

2. A resin tube according to claim 1, wherein the reinforcing wire rod has an almost semicylindrical shaped or a tunnel shaped section.

3. A resin tube according to claim 1, wherein the reinforcing wire rod is formed of non-vinyl chloride based crystalline resin material such as polypropylene, polyethylene, polyethylene terephthalate, polytetrafluoroethylene, polyacetal, polyamide, or the like.

4. A resin tube according to claim 1, wherein the tube wall is formed of non-vinyl chloride based resin material such as olefin elastomer, ethylene-vinyl acetate copolymer, styrene elastomer, polyurethane elastomer, polyester elastomer, or the like.

5. A resin tube according to claim 4, wherein the styrene elastomer is one selected from styrene-butadiene-styrene block copolymer, styrene-butadiene-styrene hydrogenated block copolymer, styrene-isoprene-styrene block copolymer, styrene-isoprene-styrene hydrogenated block copolymer, styrene-isoprene hydrogenated block copolymer.
